(19) United States
(12) Patent Application Publication
(10) Pub. No.: US 2005/0091353 A1
(43) Pub. Date: Apr. 28, 2005

(54) System and method for autonomically zoning storage area networks based on policy requirements

(76) Inventors: Sandeep K. Gopisetty, Morgan Hill, CA (US); Prasenjit Sarkar, San Jose, CA (US); Chung-Hao Tan, San Jose, CA (US)

Correspondence Address: Mark C. McCabe;IBM Corporation IP Law C4TA/J2B, 650 Harry Road, San Jose, CA, 95120, US

(21) Appl. No.: 10/676,433

(22) Filed: Sep. 30, 2003

(51) Int. Cl. G06F 15/173; G06F 15/16

(52) U.S. Cl. 709/223; 709/227; 709/230

(57) ABSTRACT

According to the present invention, there is provided a system to provide autonomically zoning of storage area networks based on system administrator defined policies. This will allow system administrators to manage the storage area network zones from a single window of control and also remove the responsibility of managing switch ports to the underlying autonomic more, the system administrator can specify policies that can changes with the growth of the storage network infrastructure. The system includes an autonomic zoning management module to autonomically generate zoning plans pertaining to network, according to a combination of each device in the network's connectivity information and user generated policies.

### FIELD OF THE INVENTION

The invention applies to the area of storage area networks (SANs), which are common in infrastructures that deal with multiple storage devices. More specifically, this invention pertains to autonomically zoning SANs based on policy requirements.

### BACKGROUND

Storage area networks consist of multiple storage devices connected by one or more fabrics. Storage devices can be of two types: host systems that access data and storage subsystems that are providers of data. Zoning is a network-layer access control mechanism that dictates which storage subsystems are visible to which hosts. This access control mechanism is useful in scenarios where the storage area network is shared across multiple administrative or functional domains. Such scenarios are common in large installations of storage area networks, such as those found in storage service providers.

The current approach to zoning storage area networks is manual and involves correlating information from multiple sources to achieve the desired results. For example, if a system administrator wants to put multiple storage devices in one zone, the system administrator has to identify all the ports belonging to the storage devices, verify the fabric connectivity of these storage devices to determine the intermediate switch ports and input all this assembled information into the zone configuration utility provided by the fabric manufacturer. This manual process is very error-prone because storage device or switch ports are identified by a 48-byte hexadecimal notation that is not easy to remember or manipulate. Furthermore, the system administrator has to also do a manual translation of any zoning policy to determine the number of zones as well as the assignment of storage devices to zones.

### SUMMARY OF THE INVENTION

According to the present invention, there is provided a system to provide autonomically zoning of storage area networks based on system administrator defined policies. This will allow system administrators to manage the storage area network zones from a single window of control and also remove the responsibility of managing switch ports to the underlying autonomic system. Furthermore, the system administrator can specify policies that can change with the growth of the storage network infrastructure. The system includes an autonomic zoning management module to autonomically generate zoning plans pertaining to a network, according to a combination of each device in the network's connectivity information and user generated policies.

There is provided a method of generating an autonomic zone plan. The method includes collecting device connectivity information for devices in a network. In addition, the method includes performing an analysis on the collected information to infer relationships between the devices. Also, the method includes identifying policies to be utilized in generating a zone plan of the network. Moreover, the method includes generating the zone plan based on a combination of the analysis performed and the identified zoning policies.

### BRIEF DESCRIPTION OF THE DRAWINGS

FIG. 1 shows a tiered overview of a SAN connecting multiple servers to multiple storage system.

FIG. 2 illustrates a method of providing autonomic zoning of a SAN, based on policy requirements, according to an exemplary embodiment of the invention.

FIG. 3 is an example of an exemplary zoning plan autonomically generated according FIG. 4 illustrates a method of generating zone plan, according to an exemplary embodiment of the invention.

### DETAILED DESCRIPTION

In the following description, for purposes of explanation, numerous specific details are set forth in order to provide a thorough understanding of the present invention. It will be evident, however, to one skilled in the art that the present invention may be practiced without these specific details.

Those skilled in the art will recognize that an apparatus, such as a data processing system, including a CPU, memory, I/O, program storage, a connecting bus and other appropriate components could be programmed or otherwise designed to facilitate the practice of the invention. Such a system would include appropriate program means for executing the operations of the invention.

An article of manufacture, such as a pre-recorded disk or other similar computer program product for use with a data processing system, could include a storage medium and program means recorded thereon for directing the data processing system to facilitate the practice of the method of the invention. Such apparatus and articles of manufacture also fall within the spirit and scope of the invention.

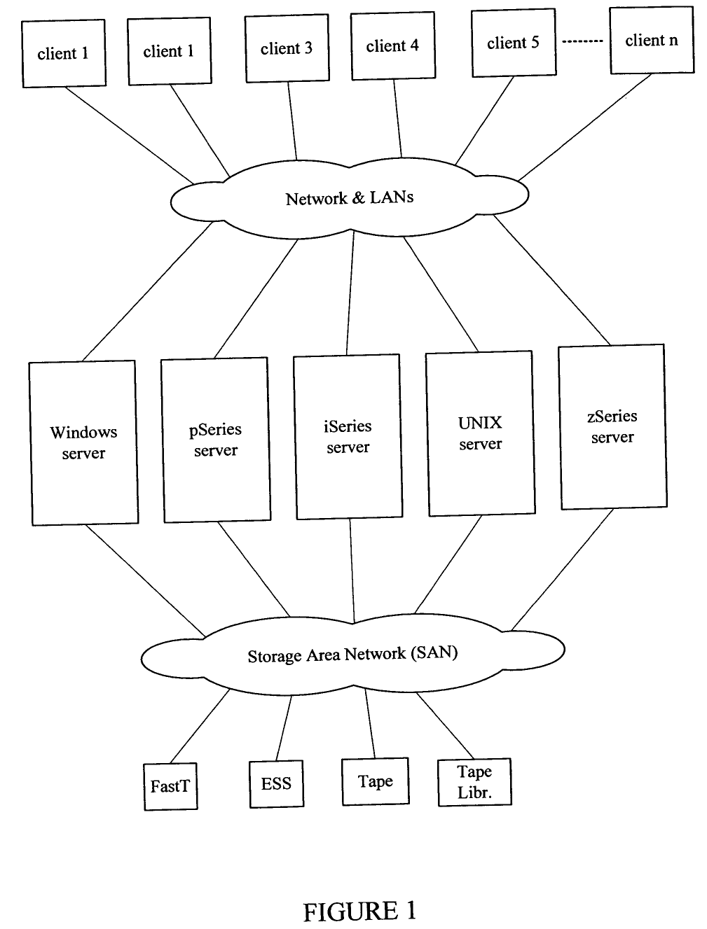

FIG. 1 shows a tiered overview of a SAN 10 connecting multiple servers to multiple storage systems. There has long been a recognized split between presentation, processing, and data storage. Client/server architecture is based on this three tiered model. In this approach, computer network can be divided into tiers: The top tier uses the desktop for data presentation. The desktop is usually based on Personal Computers (PC). The middle tier, application servers, does the processing. Application servers are accessed by the desktop and use data stored on the bottom tier. The bottom tier consists of storage devices containing the data.

In SAN 10, the storage devices in the bottom tier are centralized and interconnected, which represents, in effect, a move back to the central storage model of the host or mainframe. A SAN is a high-speed network that allows the establishment of direct connections between storage devices and processors (servers) within the distance supported by Fibre Channel. The SAN can be viewed as an extension to the storage bus concept, which enables storage devices and servers to be interconnected using similar elements as in local area networks (LANs) and wide area networks (WANs): routers, hubs switches, directors, and gateways. A SAN can be shared between servers and/or dedicated to one server. It can be local, or can be extended over geographical distances.

SANs such as SAN 10 create new methods of attaching storage to servers. These new methods can enable great improvements in both availability and performance. SAN 10 is used to connect shared storage arrays and tape libraries to multiple servers, and are used by clustered servers for failover. They can interconnect mainframe disk or tape to mainframe servers where the SAN devices allow the intermixing of open systems (such as Windows, AIX) and mainframe traffic.

SAN 10 can be used to bypass traditional network bottlenecks. It facilitates direct, high speed data transfers between servers and storage devices, potentially in any of the following three ways: Server to storage: This is the traditional model of interaction with storage devices. The advantage is that the same storage device may be accessed serially or concurrently by multiple servers. Server to server: A SAN may be used for high-speed, high-volume communications between servers. Storage to storage: This outboard data movement capability enables data to be moved without server intervention, thereby freeing up server processor cycles for other activities like application processing. Examples include a disk device backing up its data, to a tape device without server intervention, or remote device mirroring across the SAN. In addition, utilizing distributed file systems, such as IBM's Storage Tank technology, clients can directly communicate with storage devices.

SANs allow applications that move data to perform better, for example, by having the data sent directly from a source device to a target device with minimal server intervention. SANs also enable new network architectures where multiple hosts access multiple storage devices connected to the same network. SAN 10 can potentially offer the following benefits: Improvements to application availability: Storage is independent of applications and accessible through multiple data paths for better reliability, availability, and serviceability. Higher application performance: Storage processing is off-loaded from servers and moved onto a separate network. Centralized and consolidated storage: Simpler management, scalability, flexibility, and availability. Data transfer and vaulting to remote sites: Remote copy of data enabled for disaster protection and against malicious attacks. Simplified centralized management: Single image of storage media simplifies management.

Fibre Channel is the architecture upon which most SAN implementations are built, with FICON as the standard protocol for z/OS systems, and FCP as the standard protocol for open systems.

The server infrastructure is the underlying reason for all SAN solutions. This infrastructure includes a mix of server platforms such as Windows, UNIX (and its various flavors) and z/OS. With initiatives such as Server Consolidation and e-business, the need for SANs will increase, making the importance of storage in the network greater.

The storage infrastructure is the foundation on which information relies, and therefore must support a company's business objectives and business model. In this environment simply deploying more and faster storage devices is not enough. A SAN infrastructure provides enhanced network availability, data accessibility, and system manageability. The SAN liberates the storage device so it is not on a particular server bus, and attaches it directly to the network. In other words, storage is externalized and can be functionally distributed across the organization. The SAN also enables the centralization of storage devices and the clustering of servers, which has the potential to make for easier and less expensive, centralized administration that lowers the total cost of ownership.

In order to achieve the various benefits and features of SANs, such as performance, availability, cost, scalability, and interoperability, the infrastructure (switches, directors, and so on) of the SANs, as well as the attached storage systems, must be effectively managed. To simplify SAN management, SAN vendors typically develop their own management software and tools. A useful feature included within SAN management software and tools (e.g., Tivoli by IBM, Corp.) is the ability to provide zoning. Zoning is a network-layer access control mechanism that dictates which storage subsystems are visible to which hosts.

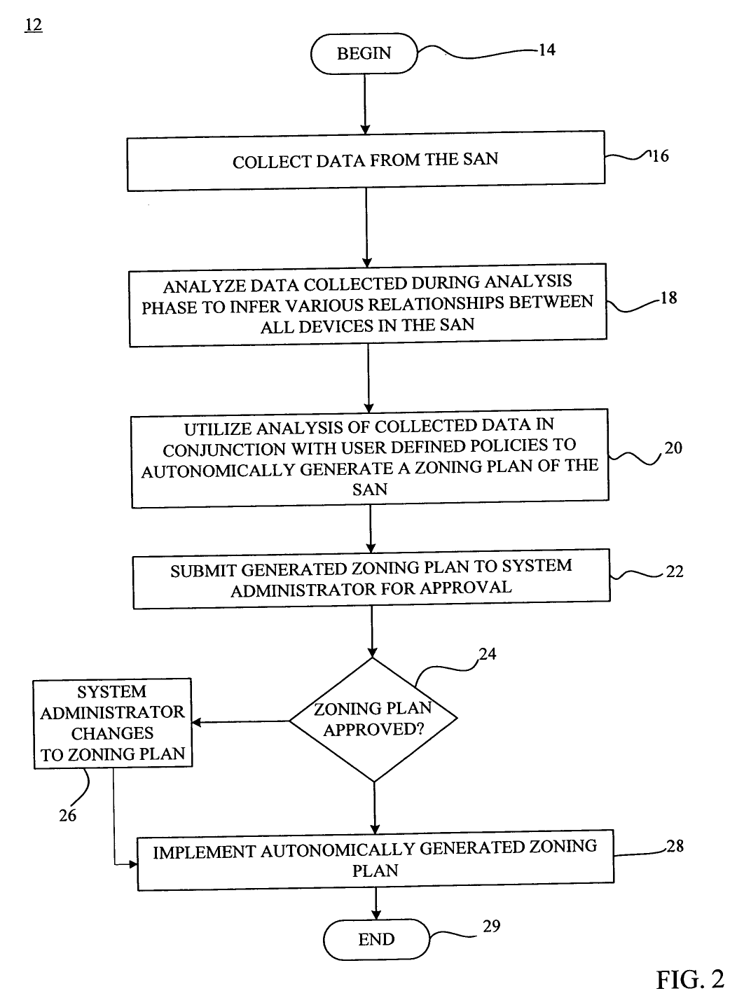

FIG. 2 illustrates a method 12 of providing autonomic zoning of a SAN, based on policy requirements, according to an exemplary embodiment of the invention. At block 14, method 12 begins. At block 16, data is collected from the SAN. This collection of data is known as the measurement phase. In the measurement phase, data is colleted from all devices in the SAN. The data is collected from all devices in the SAN via software agents. Data collection agents (agents) are placed in every principal fabric switch and every host in the storage network. The agents report back configuration data back to a configuration database. The agent in the principal fabric switch reports back the connectivity topology of the fabric. The agent in the host reports back the storage configuration of the host and the storage subsystems being used by the host at the physical or logical level. This information is collected periodically to update the configuration database. However the database is also updated when there are events that cause a physical change in the configuration such as the breakage of a network link. This phase may be likened to the monitoring phase of an autonomic loop.

At block 18, the data collected during the analysis phase is analyzed to infer various relationships between all devices in the SAN. The analysis has multiple steps pertaining to a selected fabric. First, an inventory of all the switch ports in the storage area network that are connected to a storage device is taken. Next, all storage device ports that are connected to the un-zoned switch ports are consolidated. The consolidated storage device ports are then classified as either host ports or storage subsystem ports.

The second step in the analysis phase is to determine the physical and logical connectivity of the storage area network. From the information gathered in the configuration database, an inventory of the physical connectivity of the port information collected from the previous phase is generated. The next step in the analysis phase is to determine the logical connectivity as to which hosts and storage subsystems have a storage relationship. A host and a storage subsystem is said to have a storage relationship if a host has a physical volume resident on the storage subsystem. The configuration database has enough information to infer the storage relationships between the hosts and storage subsystems. This is typically done by correlating the information gathered by SCSI INQUIRY commands issued by a software agent on the host. After storage relationships between a host and a storage subsystem are determined, the network path connectivities between the host and the storage subsystem are determined. The connectivities-are determined by doing an appropriate topological search (e.g. breadth-first).

After completing the analysis described above, the information obtained as a result of the analysis is converted into a graph structure where each node is either a switch port or a storage device port. The vertices in the graph represent the port-to-port connectivites of the storage area network. Each storage device port is also labeled by the storage subsystem or host the port belongs to. Similarly, each switch port is also labeled by the switch that is hosting the port. Finally, each vertex is labeled by the network paths (determined in the previous step) that the vertex belongs to. Note that a vertex may belong to multiple network paths.

At block 20, the analysis conducted at block 18 is utilized in conjunction with a policy or policies to generate a zone plan of the SAN. This generation of the zone plan is known as the zone plan generation phase. The policies are user generated (e.g., written in XML, etc.) and are input by a system administrator.

An important input to the zone plan generation phase are the zoning policies. The policies may be represented in XML, database tables or any language notation but refers to the attributes of any zoning policies:
Granularity: The granularity at which zoning should be done. For example, one might want coarse-grained zoning where only administrative domains are partitioned.
Device: In this particular attribute, an attempt is made to give each storage device type its own zone. The type of the device is an additional attribute.
Grouping: With this particular attribute, an attempt is made to group storage devices of similar types.
Size: The maximum size of a zone might be an attribute specified by the system administrator.
Exceptions: There might be exceptional handling of certain devices to satisfy the requirements of a system administrator.
   These policies are given as input to a zone plan generator. The zone plan generator assumes that the policy inputs are valid and consistent with each other. If inconsistent policies are found during the zone plan generation, then no zone plan is presented. For example, if one policy says that each storage device of type controller must be given its own zone, while another policy says that each storage device of type controller must be grouped together in one single zone, then the zone plan generation will be aborted.

The zone plan generation phase utilizes the zone policies as input and then goes through every storage device on SAN 10. For each storage device, the generator applies the appropriate policy to the storage device in question. The action may be to add the storage device to existing zones or to allocate a new zone for the device. Once the storage device is identified with a zone, then all storage devices that have a storage relationship with this storage device are grouped into the zone (if they are not already part of the zone). Similarly, all switch ports that are in the path from the storage device to the storage devices that have a storage relationship with this storage device are also added to the zone (if they are not already part of the zone). This continues until all the storage devices in the storage network are accounted for.

At block 22, the generated zone plan is submitted to a system administrator for approval. The system administrator may alter the plan based on personal preferences.

At decision block 24, if the plan is not approved, then the system administrator can makes changes at block 26.

At decision block 24, if the plan is approved, then at block 28 the autonomically generated zone plan is implemented in SAN 10. Implementation includes final execution of the zoning plan. During final execution of the zoning plan, the zoning included within the zoning plan is programmed onto individual switches included within the SAN according to the approved autonomically generated zoning plan. This will complete the entire autonomic loop of monitoring, analysis, planning and execution.

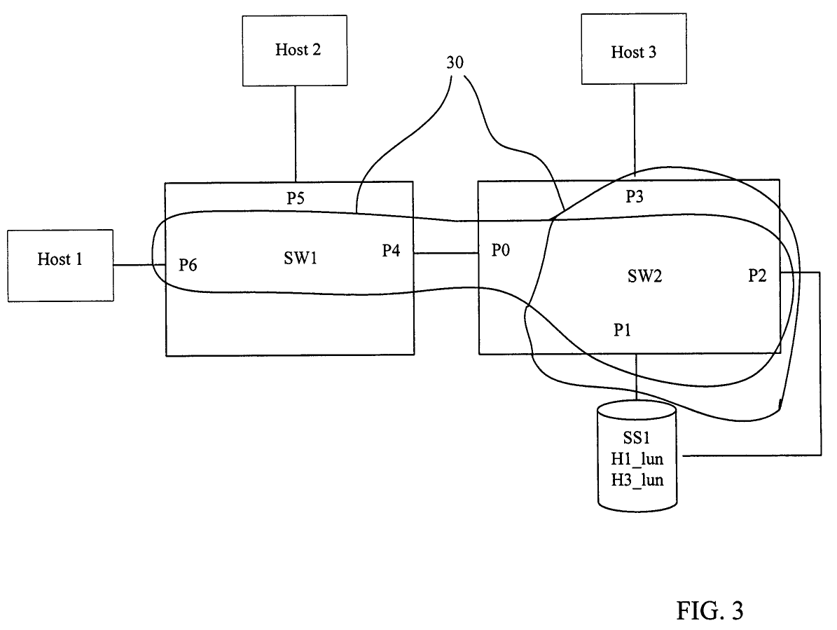

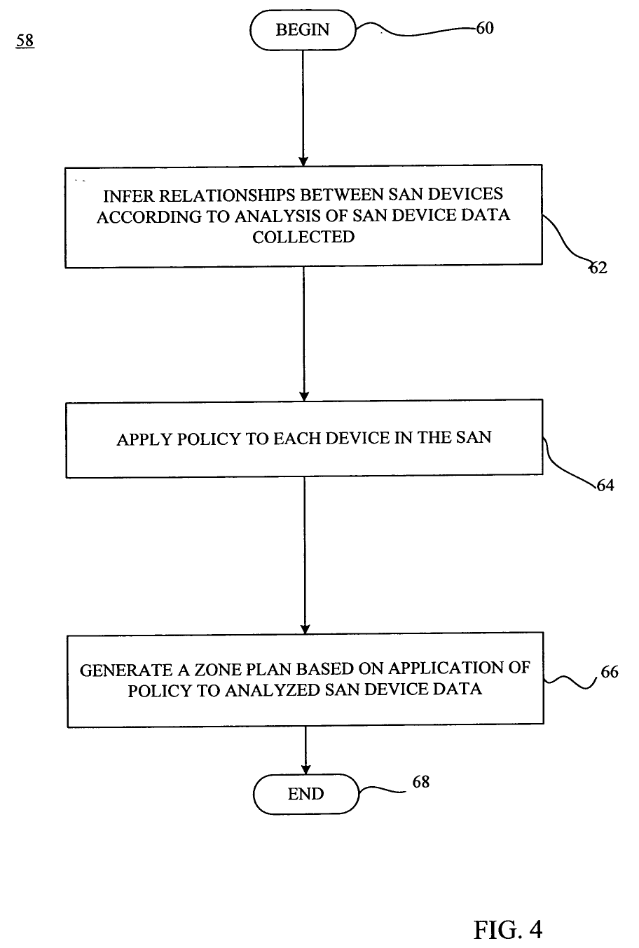

FIG. 3, illustrates an exemplary zone plan 30 generated for a SAN 32 according to an embodiment of the invention. In the generation of exemplary zone plan 30 a policy in which each storage device of type host is given its own zone is assumed. In zone plan 30, three hosts including Host1 32, Host2 34 and Host3 36 are shown. Host1 32, Host2 34 and Host3 36 are resident on SAN 32. SAN 32 also includes storage subsystem SS1 38. In addition, SAN 32 includes two switches, SW1 40 and SW2 42. SW1 40 includes switch ports P4 44, P5 46 and P6 48. SW2 includes switch ports P0 50, P1 52, P2 54 and P3 56. In SAN 32, Host1 32, Host2 34 and Host3 36 are connected to switch ports P6 48, P5 46 and P3 56. Also, in SAN 32, SS1 38 is connected dually to the switch ports P1 52 and P2 54. The switches SW1 40 and SW2 42 are cascaded to each other via the switch ports P0 50 and P4 44. Host1 32 and Host3 36 have logical units resident on the storage subsystem SS1 38 and so it can be said that Host1 32 and Host3 36 have a storage relationship with SS1 38. Finally, Host3 36 is directly connected to SS1 38, while Host1 32 needs to go through the intermediate ports P0 50 and P4 44 to reach SS1 38.

FIG. 4 illustrates a method 58 of generating zone plan 30, according to an exemplary embodiment of the invention. At block 60, method 58 begins.

At block 62, relationships between devices in SAN 32 are inferred (see block 18 in FIG. 3).

At block 64, a policy in which each storage device of type host is given its own zone, is applied (see block 20 of FIG. 3). Each device in SAN 32 is checked to determine whether it is of type host system. Host1 32, Host2 34 and Host3 36 are all of type host system and satisfy the criteria of the policy. Accordingly, a zone is autonomically created which includes Host1 32, SS1 38 (due to the storage relationship) and ports P6 48, P0 50, P4 44, P1 52, P2 54 (so as to capture all the ports in the storage relationship). No zone is created for Host2 34, because it does not have any storage relationship and we refrain from creating single-entry zones. With regards to Host3 36, a new zone is autonomically created which includes Host3 36, SS1 38 (due to the storage relationship) and the intermediate ports P1 52, P2 54 and P3 56 (due to the storage relationship).

1. A method of generating a network zone plan, comprising:
collecting device connectivity information for devices in a network;
performing an analysis on the collected information to infer relationships between the devices;
identifying policies to be utilized in generating a zone plan of the network; and
generating the zone plan base3d on a combination of the analysis performed and the identified zoning policies.

2. The method of claim 1 wherein the network is a storage area network (SAN).

3. The method of claim 1 wherein the zone plan dictates which of the devices are visible to each other.

4. The method of claim 3 wherein the devices include host systems to access data and storage subsystems which are providers of data.

5. The method of claim 4 wherein the zone plan is a network-layer access control mechanism which dictates which storage subsystems are visible to which hosts.

6. The method of claim 1 further comprises presenting the zone plan for approval, wherein the zone plan is not implemented until approval is received.

7. A computer program product having instruction codes for providing autonomic zoning in a storage area network, comprising:
a first set of instruction codes for collecting device connectivity information for devices in a network;
a second set of instruction codes for performing an analysis on the collected information to infer relationships between the devices;
a third set of instruction codes for identifying policies to be utilized in generating a zone plan of the network; and
a fourth set of instruction codes for generating the zone plan based on a combination of the analysis performed and the identified zoning policies.

8. The computer program product of claim 7 wherein the network is a storage area network (SAN).

9. The computer program product of claim 7 wherein the zone plan dictates which of the devices are visible to each other.

10. The computer program product of claim 9 wherein the devices include host systems to access data and storage subsystems which are providers of data.

11. The computer program product of claim 10 wherein the zone plan is a network-layer access control mechanism which dictates which storage subsystems are visible to which hosts.

12. The computer program product of claim 7 further comprises presenting the zone plan for approval, wherein the zone plan is not implemented until approval is received.

13. A system to provide autonomic zoning in a network, comprising:
a autonomic zoning management module to autonomically generate zoning plans pertaining to a network, according to a combination of each device in the network's connectivity information and user generated policies.
